(19) United States
(12) Patent Application Publication
(10) Pub. No.: US 2002/0094704 A1
(43) Pub. Date: Jul. 18, 2002

(54) Arrangement for the identification of the logical composition of a modular system

(76) Inventors: Andreas Goers, Pattensen (DE); Helmut Michel, Hannover (DE); Reiner Bleil, Peine (DE)

Correspondence Address: Michael M. Rickin, 29801 Euclid Avenue-4U6, Wickliffe, OH, 44092-1898, US

(21) Appl. No.: 10/000,519

(22) Filed: Oct. 23, 2001

(30) Foreign Application Priority Data
Oct. 24, 2000 (DE) 10052627.6

(51) Int. Cl. H01R 12/00

(52) U.S. Cl. 439/65

(57) ABSTRACT

The invention relates to a method and an arrangement for the identification of the logical composition of a modular system comprising an electrical base unit (1) with a plurality of slots each for receiving a pluggable electrical unit (2), each pluggable electrical unit (2) being electrically connected to the base unit (1) by means of a multi-pin plug-in connection comprising a plug-in contact device (23) and a mating plug-in contact device (13) and the base unit (1) being provided with signal processing means (12). Each pluggable electrical unit (2) is provided with an addressable serial read-only memory (21) for receiving identifiers clearly identifying this unit. The read-only memory (21) is connected via a serial bus (3) to the signal processing means (12) of the base unit (1). The serial bus (3) is physically formed by two bus lines (31,32) with a synchronized alternation of successive signal levels. The read-only memories (21) of all the pluggable electrical units (2) are addressed identically and in a way permanently set on the pluggable electrical unit (2). Of the two bus lines (31,32) of the serial bus (3), one bus line (31) is commonly connected to all the read-only memories (21) and the signal processing means (12) and the second bus line (32) in each case is separately connected to a read-only memory (21) and the signal processing means (12).

### DESCRIPTION

The invention relates to an arrangement for the identification of the logical composition of a modular system.

Complex electrical engineering systems, in particular in measuring and control technology and in telecommunications, are often of a modular construction. This involves a large number of electrical units being accommodated in an enclosure of an electrical base unit in a pluggable manner and connected in each case to the base unit via a multi-pin plug-in connection.

When a complex system of this type is expanded by adding further pluggable electrical units while operation is in progress or when one of the pluggable electrical units is exchanged, there is the risk of other electrical units being disrupted. Physically added pluggable electrical units are logically unknown to the base unit. In addition, it is necessary to distinguish between different pluggable electrical units with an identical mechanical type of construction.

It is known from the publication “Implementing a Flexible Serial Bus for Board Identification”, CSD Magazine, August 1998, to equip every pluggable electrical unit with a serial read-only memory with an I²C interface (I²C: Inter Integrated Circuit) and to connect all the pluggable electrical units to one another via a serial I²C bus routed in the base unit and connect them to a bus master arranged in the base unit. Identifiers clearly identifying the respective pluggable electrical unit are stored in the serial read-only memories.

Modules with an I²C interface have an eight-bit-wide module address, of which four bits are already permanently preallocated by internal wiring for the coding of the module type and cannot be altered by the user. One bit is reserved for controlling the direction of data transmission. The remaining three bits of the module address are available for addressing a total of eight modules of the same type on the same I²C bus. Accordingly, a modular system equipped in such a way is limited to a total of eight pluggable electrical units. To get around this limitation, it is proposed, while pointing out the increasing complexity of the software and additionally required input/output terminals for the bus master, to provide a plurality of I²C bus segments for eight pluggable electrical units in each case, with the complexity of the addressing still persisting.

The invention is therefore based on the object of providing an uncomplicated way of determining the logical composition of a modular system, identifying the components physically contained and at the same time managing with the smallest possible number of contacts of the plug-in connection.

According to the invention, this object is achieved by the means of Patent claim 1. Advantageous configurations of the invention are given in the dependent claims.

The invention is based on a modular system comprising an electrical base unit with a plurality of slots each for receiving a pluggable electrical unit, each pluggable electrical unit being electrically connected to the base unit by means of a multi-pin plug-in connection comprising a plug-in contact device and a mating plug-in contact device and the base unit being provided with signal processing means. Each pluggable electrical unit is provided with an addressable serial read-only memory for receiving identifiers clearly identifying this unit. The read-only memory is connected via a serial bus to the signal processing means of the base unit. The serial bus is physically formed by two bus lines with a synchronized alternation of successive signal levels.

The essence of the invention is that the read-only memories of all the pluggable electrical units are addressed identically and in a way permanently set on the pluggable electrical unit and that, of the two bus lines of the serial bus, one bus line is commonly connected to all the read-only memories and the signal processing means and the second bus line in each case is separately connected to a read-only memory and the signal processing means.

Accordingly, only the two bus lines of the serial bus are led to the plug-in connection of each slot. The arrangement for the identification of the logical composition of a modular system advantageously manages with the small number of precisely two contacts of each plug-in connection at the slot.

As a result of the identical address of each read-only memory, permanently set on the pluggable electrical unit, all the read-only memories are operated under the same address in the data traffic via the bus lines and there is no address administration within the data packets. As a result, the complexity of the software is advantageously reduced.

The invention is explained in more detail below on the basis of an exemplary embodiment. In the drawings required for this purpose:

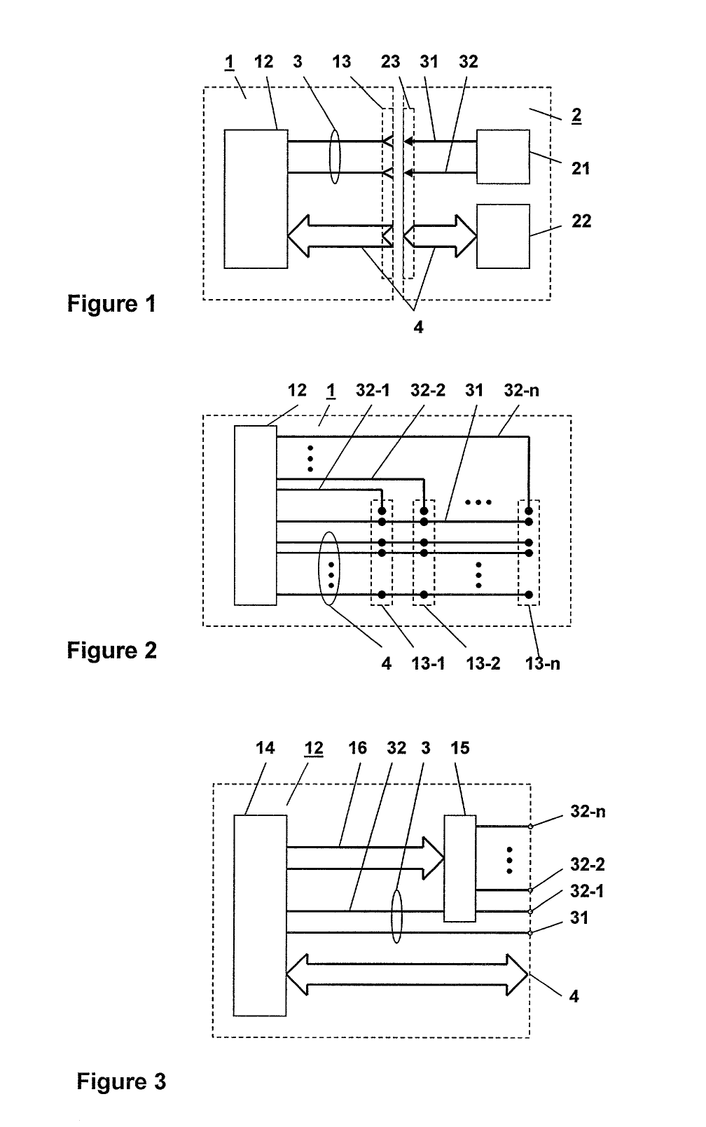

FIG. 1 shows a basic circuit diagram of a pluggable electrical unit connected to the base unit

FIG. 2 shows a detailed representation of the base unit

FIG. 3 shows a detailed representation of the signal processing means

Represented in FIG. 1 is a basic diagram of a pluggable electrical unit 2 connected to a base unit 1, only the means necessary for explaining the invention being shown. The pluggable electrical unit 2 has a plug-in contact device 23, to which a first bus line 31 and a second bus line 32 are connected, with a synchronized alternation of successive signal levels of a serial bus 3 and lines of a communication bus 4. The functionality of the pluggable electrical unit 2 is accommodated in module electronics 22, which are connected to the communication bus 4. In addition, each pluggable electrical unit 2 is provided with a serial read-only memory 21, which is connected to the bus lines 31 and 32 of the serial bus 3. Identifiers clearly identifying the respective pluggable electrical unit 2 are stored in the serial read-only memory 21. In addition, it may be envisaged to store individual configuration data of the pluggable electrical unit 2 in the serial read-only memory 21 in such a way that they can be called up.

The read-only memories 21 of all the pluggable electrical units 2 are addressed identically and in a way permanently set on the pluggable electrical unit 2. Accordingly, all the read-only memories 21 are operated under the same address in the data traffic via the bus lines 31 and 32. The accessible address terminals are preferably connected to frame potential. The read-only memories 21 of all the pluggable electrical units 2 can consequently be operated identically under the address 0.

For receiving a pluggable electrical unit 2, the base unit 1 has a mating plug-in contact device 13, corresponding to the plug-in contact device 23 of the pluggable electrical unit 2. In addition, the base unit 1 is provided with a signal processing means 12, which is connected to the mating plug-in contact device 13 via the communication bus 4 and the serial bus 3.

For receiving a plurality of pluggable electrical units 2, according to FIG. 2 the base unit 1 is provided with a plurality of n slots, each assigned a mating plug-in contact device 13-1 to 13-n. The signal processing means 12 of the base unit 1 are connected to the mating plug-in contact devices 13-1 to 13-n of all the slots via the lines of the communication bus 4 and the serial bus 3. In this case, one bus line 31 of the serial bus 3 is commonly connected to all the mating plug-in contact devices 13-1 to 13-n. The second bus line 32-1 to 32-n of the serial bus 3 in each case is separately connected to one of the mating plug-in contact devices 13-1 to 13-n and the signal processing means 12.

Accordingly, the serial bus 3 to the first slot of the base unit 1 with the mating plug-in contact device 13-1 is formed by the bus lines 31 and 32-1. The serial bus 3 to the second slot of the base unit 1 with the mating plug-in contact device 13-2 is formed by the bus lines 31 and 32-2 and the serial bus 3 to the nth slot of the base unit 1 with the mating plug-in contact device 13-n is formed by the bus lines 31 and 32-n.

Accordingly, only two bus lines 31/32-1, 31/32-2 to 31/32-n of the serial bus 3 are led to the mating plug-in contact devices 13-1 to 13-n of each slot. As a result of this and the permanent and identical addressing of the read-only memories 21 of the pluggable electrical units 2, the arrangement for the identification of the logical composition of a modular system manages with the small number of precisely two contacts of each mating plug-in contact device 13-1 to 13-n at the slot, while maintaining the distinguishability of the individual read-only memories 21.

The signal processing means 12 essentially comprise a microcontroller with a processing unit, memory units and input/output units. Microcontrollers of this type are known per se. For example, the type 80C517 is equipped with 56 digital input/output terminals, which are grouped together in seven bidirectional 8-bit ports. Each of these 56 port terminals can itself be configured as desired as an input or output terminal. By alternately successive configuration as an input terminal and output terminal, each port terminal can be set as a bidirectional terminal for successive reading and writing. In addition, the microcontroller has control-signal terminals of a predetermined and unalterable logical signal assignment and direction of signal transmission.

In a first embodiment, it is envisaged for a small number n of slots according to FIG. 2 to connect the bus lines 31 and 32-1 to 32-n directly to one of the port terminals of the microcontroller in each case. The microcontroller is operated by means of the operating software as the bus master of the serial bus 3 with respect to the port terminals wired to the bus lines 31 and 32-1 to 32-n. In this case, for the communication with the read-only memory 21 of a selected pluggable electrical unit 2 by the operating software of the microcontroller, the data stream of the second bus line 32 is passed via the specific port terminal which is connected to the second bus line 32 led to the slot of the selected pluggable electrical unit 2, while the other port terminals, occupied with second bus lines 32-1 to 32-n, are kept inactive.

For a larger number n of slots, in FIG. 3 a second embodiment is represented. The signal processing means 12 are provided not only with a microcontroller 14 but also with a signal distributor 15. The signal distributor 15 has address terminals for the connection of slot-address signal lines 16, a single signal terminal and a group of n signal terminals, the individual signal terminal being bidirectionally connected to precisely one signal terminal of the group of n signal terminals in accordance with the slot address supplied to the address terminals.

Each signal terminal of the group of n signal terminals is wired with one of the second bus lines 32-1 to 32-n. The single signal terminal is connected via the second bus line 32 of the serial bus 3 to a port terminal of the microcontroller 14. In addition, the slot-address signal lines 16 and the first bus line 31 are connected to further port terminals of the microcontroller 14.

By means of the operating software, the microcontroller is operated as the bus master of the serial bus 3 with respect to the port terminals wired with the bus lines 31 and 32. In this case, for the communication with the read-only memory 21 of a selected pluggable electrical unit 2 by the operating software of the microcontroller, firstly the associated slot address on the port terminals wired with the slot-address signal lines 16 is output. The data stream of the second bus line 32 is passed via the signal distributor 15 and assigned to the associated individual second bus line 32-1 to 32-n, led to the slot of the selected pluggable electrical unit 2. In this way, it is possible to distinguish between and individually address a comparatively large number n of slots by means of a small number of port terminals.

The serial bus 3 comprising two bus lines 31 and 32 with a synchronized alternation of successive signal levels is configured as an I²C bus. The specification of the I²C bus known per se is described in detail in “I²C-Bus angewandt—Chips und Schaltungen” [I²C bus in use—chips and circuits], Elektor Verlag Aachen, 1995. According to the I²C specification, the two bus lines 31 and 32 of the I²C bus are referred to as the data line SDA and the clock line SCL.

In a first configuration of the first and second embodiments, the bus line 31 is the clock line SCL and the bus line 32 is the data line SDA. Accordingly, the clock line 31 is universally connected to all the mating plug-in contact devices 13-1 to 13-n, while the data line 32 is individualized slot-specifically.

In a second configuration of the first and second embodiments, the bus line 31 is the data line SDA and the bus line 32 is the clock line SCL. Accordingly, the data line 32 is universally connected to all the mating plug-in contact devices 13-1 to 13-n, while the clock line 31 is individualized slot-specifically.

In each configuration of each embodiment, the common first bus line 31 and a selected second bus line 32-1 to 32-n are in each case subjected to the synchronized alternation of successive signal levels as intended, in accordance with the I²C specification. The read-only memory 21 of the pluggable electrical unit 2 at the slot selected by the selected second bus line 32-1 to 32-n and the microcontroller 14 of the signal processing means 12 form the stations served by the serial I²C bus 3. All the other read-only memories 21 are excluded from the communication with the microcontroller 14 as a result of having no synchronized alternation of successive signal levels in accordance with the I²C specification.

The identifiers clearly identifying the respective pluggable electrical unit 2 are read out by the microcontroller 14. In this way, every second bus line 32-1 to 32-n is successively selected and the identifying identifiers of the respective pluggable electrical unit 2 are read out from the associated read-only memory 21. When the identifying identifiers of all the inserted pluggable electrical units 2 have been acquired, the logical composition of the modular system has been identified.

It is to be understood that the description of the preferred embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. Arrangement for the identification of the logical composition of a modular system comprising an electrical base unit with a plurality of slots each for receiving a pluggable electrical unit, each pluggable electrical unit being provided with an addressable serial read-only memory for receiving identifiers clearly identifying this unit and being connected to the base unit by means of a multi-pin plug-in connection comprising a plug-in contact device and a mating plug-in contact device and the base unit being provided with signal processing means, which are connected to the serial read-only memory via a serial bus, which is physically formed by two bus lines with a synchronized alternation of successive signal levels,
characterized
in that the read-only memories (21) of all the pluggable electrical units (2) are addressed identically and in a way permanently set on the pluggable electrical unit (2) and
in that of the two bus lines (31, 32) of the serial bus (3) one bus line (31) is commonly connected to all the read-only memories (31) and the signal processing means (12) and the second bus line (32-1 to 32-n) in each case is separately connected to a read-only memory (21) and the signal processing means (12).

2. Arrangement according to claim 1,
characterized
in that the two bus lines (31,32) of the serial bus (3) comprise one clock line (31) and one data line (32) and in that the clock line (31) is commonly connected to all the read-only memories (21).

3. Arrangement according to claim 1,
characterized
in that the two bus lines (31,32) of the serial bus (3) comprise one clock line (32) and one data line (31) and in that the data line (31) is commonly connected to all the read-only memories (31).

4. The arrangement of claim 1 wherein said serial bus is an I²C bus.

5. The arrangement of claim 2 wherein said serial bus is an I²C bus.

6. The arrangement of claim 3 wherein said serial bus is an I²C bus.
